(19) United States
(12) Patent Application Publication
(10) Pub. No.: US 2015/0143705 A1
(43) Pub. Date: May 28, 2015

(54) Power Tool, Saw Blade and Power Tool System

(71) Applicant: Robert Bosch GmbH, Stuttgart (DE)

(72) Inventor: Milan Bozic, Solothurn (CH)

(21) Appl. No.: 14/550,940

(22) Filed: Nov. 22, 2014

(30) Foreign Application Priority Data
Nov. 22, 2013 (DE) 10 2013 223 930.0

(51) Int. Cl. B23D 51/10

(52) U.S. Cl. CPC B23D 51/10
USPC 30/166.3; 83/835

(57) ABSTRACT

A sawing power tool, in particular a sawing hand-held power tool, includes at least one clamping mechanism that is configured to fasten a saw blade to be driven with a stroke motion. In one embodiment, the at least one clamping mechanism fastens a compass saw blade that has a blade body which includes a cutting edge with cutting teeth and that has a fastening shaft. The at least one clamping mechanism has at least one geometric structure that forms a form-closure element that is configured to form a connection to at least one at least portionally inverse form-closure element of the saw blade.

This application claims priority under 35 U.S.C. §119 to patent application no. DE 10 2013 223 930.0, filed on Nov. 22, 2013 in Germany, the disclosure of which is incorporated herein by reference in its entirety.

### BACKGROUND

The disclosure relates to a sawing power tool, in particular a sawing hand-held power tool, comprising at least one clamping means for fastening a saw blade to be driven with a stroke motion, in particular for fastening a compass saw blade that has a blade body comprising a cutting edge with cutting teeth, and that has a fastening shaft.

US 2005/0235799 A1 describes a compass saw blade, or saber saw blade, which has a rectilinear saw blade that comprises a fastening shaft, the fastening shaft having locally differing thicknesses and being realized with a circular through hole for fixing the saw blade.

### SUMMARY

The disclosure is based on the object of realizing through simple design means a saw blade, in particular a saw blade for a compass saw, or saber saw, that executes an oscillating stroke motion when in operation, such that a maximally precise stroke motion of the saw blade is possible over a long operating period.

This object is achieved by a sawing power tool, in particular a sawing hand-held power tool, comprising at least one clamping means for fastening a saw blade to be driven with a stroke motion, in particular for fastening a compass saw blade that has a blade body comprising a cutting edge with cutting teeth, and that has a fastening shaft. According to the disclosure, it is proposed that the at least one clamping means have at least one geometric structure, which forms a form-closure element provided to form a connection to at least one at least portionally inverse form-closure element of the saw blade.

The disclosure enables the torsional motion of the saw blade to be reduced. The form-closed clamping between the clamping means of the power tool and those of the saw blade results in improved power efficiency. Furthermore, the pressure load on the shaft is reduced, since the at least partially inverse form-closure elements constitute a greater contact surface area.

A “clamping means” in this context is to be understood to mean at least one means that serves to fasten an insert tool, in particular a saw blade. In this case, at least one clamping means of the power tool is brought into engagement with the saw blade, the saw blade being clamped in by the clamping means and thereby producing a secure connection. The clamping means may be constituted, at least partially, by a clamping jaw or chuck jaw of a tool receiver, preferably by a coupling, in particular of a clamping device. The clamping means has at least one structure that is at least partially inverse in relation to a stamped structure on the saw blade. The at least one structure of the clamping means may also be realized by a form-closed connection, in addition to the force-closed connection.

An “impression” in this context is to be understood to mean a hollow, on at least one side face of the fastening shaft of the saw blade, that can be produced by forming, in particular by stamping. In this case, on a side face of the saw blade that is opposite to the impression, the stamping may produce a prominence that corresponds to the hollow. The hollows produced by stamping have an impression depth of at least 1 mm, preferably at least 0.8 mm, in particular at least 0.5 mm. Alternatively, the impressions could also be produced by milling, forming, or another method considered appropriate by persons skilled in the art. The impressions may be made in the same side face of the saw blade, in particular at least the side face of the fastening shaft of the saw blade, such that there are only hollows on this side face, and on the opposite side face there are only the prominences that correspond to the hollows. Alternatively, stampings may be realized on both side faces, at least of the fastening shaft. Thus both side faces, at least of the fastening shaft, may have hollows and prominences.

The hollows and prominences may be realized as form-closure elements.

In an advantageous development, the stampings in the fastening shaft are realized, at least partially, in the blade body of the saw blade, thereby increasing the stiffness in the boundary region between the fastening shaft and the blade body of the saw blade.

Furthermore, it is advantageous that the impressions in the saw blade are easily produced. Impressions in the saw blade result in a strengthening in the saw blade, and consequently in altered stress characteristics. In particular, impressions at the transition between the fastening shaft and the blade body may produce very good results for the state of stress of the saw blade.

It is also possible, however, to produce the impression by rolling, in particular by simultaneous rolling on both side faces of the blade body, in that the saw blade is moved through between two contradirectional rollers, with impressions, in the form of hollows, being impressed on both side faces of the saw blade. In this case, the material in the blade body may become compressed in the region of the impressions. The impression is thus preferably produced by stamping, but may possibly also be produced by rolling, and results in a strengthening of the saw blade, thereby improving the stress characteristics and vibration transmission characteristics. In particular, no material is removed from the saw blade in the operation of producing the impression.

The dependent claims specify expedient developments of the power tool according to the disclosure.

The structure of the clamping means may be realized as at least one recess and/or at least one protuberance. The at least one structure of the clamping means may be realized as at least one form-closure element. At least one structure of the clamping means may have a recess made into a clamping face of the clamping means, and/or a protuberance protruding from a clamping face of the clamping means. Improved clamping of the saw blade is achieved as a result. For the user of the power tool, improved manipulation can be achieved in the operation of clamping the saw blade into the power tool, since latching of the impressions of the saw blade into the structures of the clamping means is perceived immediately by the user. Structures in the clamping means therefore, inter alia, also reduce the time taken to change the saw blades.

For the purpose of resetting a saw blade, in particular the fastening shaft of such a saw blade, the tool receiver may be realized with a first clamping means and a second clamping means. Like the structure of the first clamping means, there may be, in the second clamping means, an inverse structure that is realized, at least partially, to correspond to at least one contour of the first clamping means, in particular being at least partially congruent. Alternatively or additionally, the first clamping means and the second clamping means may have structures of the same shape, preferably form-closure elements of the same shape, in particular hollows and/or prominences of the same shape. This enables the saw blade to be fixed in the tool receiver in a rapid, uncomplicated manner, since impressions on the saw blade can be aligned with a precise fit.

The structures, in particular the protuberances and/or recesses, of the clamping means preferably extend along two mutually transverse, in particular mutually perpendicular, directions that span the clamping face, the height/depth of the protuberance/recess being denoted by a third direction extending transversely in relation to the clamping face. For example, the protuberance/recess may extend to form a geometric shape, and constitute a circular, rectangular, linear and/or curved shape. However, the geometric shape of the structure of the at least one clamping means is not limited to a circular, rectangular, linear and/or curved shape, but may also assume alternative geometric shapes or combinations of geometric shapes or partial shapes.

“Form-closure element” in this context is to be understood to mean an element that can form a form-closed connection to a further form-closure element. A form closure may be realized by at least one relief, in particular a step, a shoulder, a projection or a stop. The form-closure element in this case may be made on the clamping means and/or on the saw blade of the hand-held power tool. Alternatively or additionally, a form-closure element may be understood to mean an element in the form of a line, an edge, a point, or a plurality of points and/or a face, realized, at least portionally, along the at least one contour of a connection partner.

The form-closure element acts in combination with at least one further, corresponding form-closure element on the saw blade, or on the clamping means. A form closure thus has two at least portionally inverse form-closure elements, which advantageously impede each other in the relative movement in relation to each other and thereby realize a secure connection. The form-closure elements of a first connection partner in this case may be realized such that they are at least partially parallel to the form-closure elements of a corresponding connection partner.

In an advantageous design, the structure of the at least one clamping means is realized by a protuberance. The at least one protuberance in a clamping means can ideally be brought into at least one impression in the saw blade, or coupled to at least one impression in the saw blade. A secure mounting of the saw blade, with at least one clamping jaw, is thus realized.

Furthermore, the at least one structure of the clamping means may have at least one recess. Since an impression of the saw blade realizes a corresponding prominence on the opposite side, this prominence can be brought into engagement with a recess of the clamping means. This enables the saw blade to be held in an advantageously secure manner in the tool receiver.

Structures realized in a variety of ways are possible according to the disclosure. For example, a possibility is that of substantially linear or strip-type structures that have either a rectilinear or curved shape, or that may be substantially rectilinear and have at least partially curved portions. In the case of a linear structure, the width of the structure is very small; in the case of a strip-type structure, the width is preferably maximally one third of a longitudinal extent of the clamping faces, for example 3 mm, with greater or lesser widths also being possible. Also possible, in principle, are flat structures on the clamping faces of the clamping means. Linear or strip-type structures provide an enlarged effective area with the impressions, such that relative movements are prevented in an effective manner, at least in two spatial directions. By contrast, curved portions enlarge the effective areas in a plurality of directions, and thus protect against relative movements perpendicular to the curvature. As a result of an enlarged effective area, the pressure load upon the fastening shaft is reduced. This affects the stress balance of the saw blade in the transition region between the blade body and the fastening shaft. The structures provide a simple, advantageous means of absorbing forces and moments.

Furthermore, it is possible, in particular in the case of a linear structure, to produce circumferentially closed geometric patterns, for example an approximately rectangular structure, triangular structure or the like. A circumferentially closed linear structure on the clamping means, together with corresponding inverse impressions on the saw blade, inhibits a relative movement and ensures that the saw blade is fixed in the tool receiver in an advantageous manner.

It may be expedient, in the case of a linear or strip-type structure, for the impression to extend at least portionally in the longitudinal direction, i.e. parallelwise in relation to the stroke direction of the machine, or of the saw blade. Alternatively or additionally, the linear or strip-type structures may extend at least portionally in the longitudinal direction, and/or diagonally in relation to the longitudinal direction. Also possible, in principle, is an angular, preferably right-angled or diagonal, alignment, in particular at an angle of approximately 45° in relation to the alignment of the linear or strip-type structure in respect of the stroke direction, or orthogonally, in the transverse direction in relation to the stroke direction. Also possible are various types of geometric patterns of structures that can be represented as a combination of differing structures, for example a combination of rectilinear structures extending portionally in the longitudinal direction and in the transverse direction, or diagonally, at an angle in relation to the longitudinal axis. An angular design of the structures of the clamping means inhibits the relative movement of the saw blade in the tool receiver, between the clamping means and the saw blade, in a direction that is subject to high stresses, and thus realizes a homogeneous flow of stress in the saw blade. The stress can be adapted locally, according to the alignment of the mutually contacting structures of the clamping means and of the impressions of the saw blade, thereby making it possible to avoid stress concentrations.

Advantageously, the structures are arranged in the shape of a cross. The cross-shaped arrangement in this case may be produced by at least two linear or strip-type structures arranged transversely in relation to each other. In this case, the structures may have a point of intersection. The application of impressions has the effect of further increasing the strength locally in the transition region that is subject to high loads, in particular between the fastening shaft and the blade body, in the saw blade.

Preferably, at least one structure on a clamping means extends as far as a side edge of the clamping means. It may be expedient to provide one or more impressions adjacent to the fastening shaft, or in the transition region between the blade body and the fastening shaft, since the transition region is subject to high stresses, in particular in the case of high flexural loads, and the strength can be increased in the transition region by the application of the impressions, such that the risk of an unacceptable deformation or a fracture of the saw blade can be reduced. At least one impression of the saw blade, which connects the fastening shaft and the blade body, would therefore be advantageous. The impressions may be arranged on sides of the blade body and/or directly adjacent to the blade body, on sides of the fastening shaft.

Moreover, the saw blade is realized as a blade body comprising a cutting edge with cutting teeth, and having a fastening shaft, the blade body and/or the fastening shaft having at least one impression, which is provided to form a connection to a form-closure element of the hand-held power tool. This enables the saw blade to be clamped in the hand-held power tool in a secure and fixed manner. In addition, relative movements of the saw blade in the tool receiver are minimized or prevented. The connection may be realized as a force-closed and/or form-closed connection. The connection may be construed as any connection considered appropriate by persons skilled in the art.

Preferably, the fastening shaft of the saw blade has an impression. The impression on the fastening shaft can be brought into engagement, at least partially, with the structures of the at least one clamping means. The impressions in this case have structures that, in particular, are realized so as to be substantially of the same kind as the contours of the clamping means, at least partially. This enables the tool receiver to be fixedly connected to the fastening shaft of the saw blade. Moreover, the strength and stiffness of the fastening shaft can be increased by the process of forming and hardening.

Preferably, the blade body has at least one impression. This results in increased stiffness of the blade body as a whole. Alternatively or additionally, the impressions may be made in the fastening shaft and in the blade body of the saw blade.

The tool receiver according to the disclosure thus enables the saw blade to be fastened to the power tool, in particular to the saw, in a reliable manner, and additionally also provides increased stability of the saw blade, because of the structures made in the saw blade.

### BRIEF DESCRIPTION OF THE DRAWINGS

Further advantages are given by the following description of the drawings. The drawings show exemplary embodiments of the disclosure. The drawings, the description and the claims contain numerous features in combination. Persons skilled in the art will also expediently consider the features individually and combine them to create appropriate further combinations.

There are shown in the drawings:

FIG. 1 a perspective view of a saw blade with associated clamping means,

FIG. 2 a perspective view of the saw blade and the clamping means according to FIG. 1 in the clamped-in state, and

FIG. 3 a further perspective view of the saw blade and the clamping means in the clamped-in state.

### DETAILED DESCRIPTION

In the figures, components that are the same are denoted by the same references.

The following figures each relate to a tool receiver, at least one clamping means 1 and a saw blade 31 to be clamped, for a power tool having a translationally oscillating working motion. The power tool may be, in particular, a hand-held power tool, preferably a compass saw or saber saw. However, the power tool according to the disclosure could also have rotationally oscillating working motions.

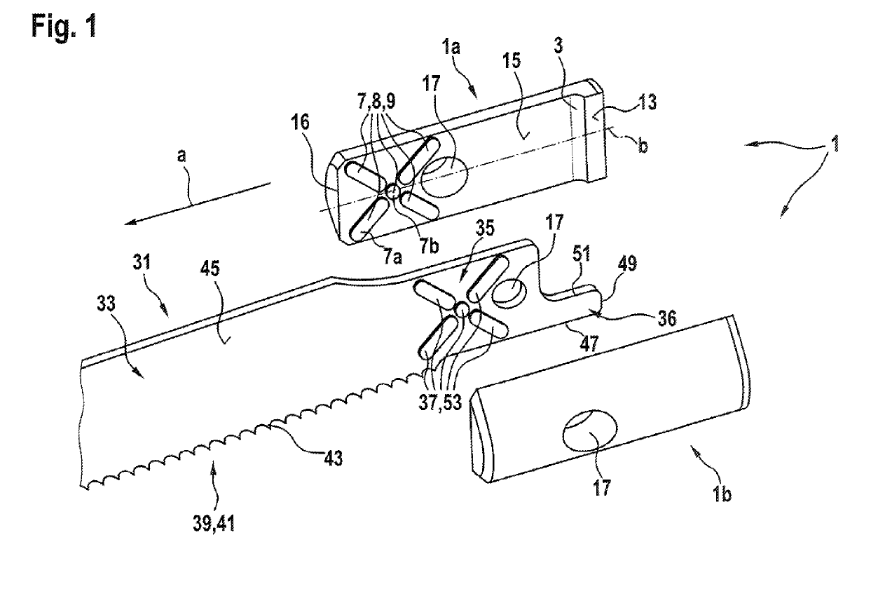

The tool receiver according to FIG. 1 shows two clamping means 1 and a saw blade 31. The clamping means 1 are arranged separately, as a first clamping means 1a and a second clamping means 1b; alternatively, they may also be realized as a single piece. The first clamping means 1a has a substantially semi-cylindrical body, from which material has been removed flatly along the cylinder axis b, such that the semi-cylinder represents a bearing contact face 13 on a substantially flat face. A further partial removal of material, approximately along the cylinder axis b and parallel to the bearing contact face 13, forms the clamping face 15. The clamping face 15 thus extends as far as a shoulder 3, which denotes the bearing contact face 13. There is a circular through opening 17 made orthogonally in relation to the clamping face 15.

In the immediate vicinity of the through opening 17, there are structures 7 arranged in the direction of the blade body 33. The arrangement of the structures 7 according to the embodiment of FIG. 1 is characterized by four elongate, linear structures 7a and a circular structure 7b. The elongate, linear structures 7a in this case are angled in relation to the stroke direction a of the saw blade 31, in particular arranged at an angle of approximately 45°. Two of the elongate, linear structures 7a extend along one line, and run toward the stroke direction a, going out with a directional component from the cutting edge 41, rising in the direction of the blade body 33. The other two linear structures 7a likewise extend along one line, but run contrary to the stroke direction a, going out with a directional component from the cutting edge 41, rising in the direction of the blade body, such that the structures 7 realize a cross shape, wherein the structures 7 do not intersect. The circular structure 7b is made at the point of intersection of the two notional lines of the linear structures 7a, or at the point of intersection of the cross shape. The structures 7 of the first clamping means 1 a project out of the clamping face 15 of the first clamping means 1a, and are realized as protuberances 9. The second clamping means 1b is similar in design to the first clamping means 1a.

Alternatively or additionally, the second clamping means 1b may have structures 7 that are recessed into the clamping face 15 of the second clamping means 1b, i.e. these structures 7 may be realized such that they can engage with those prominences 53 that correspond to the impressions 37 in the saw blade 31.

The saw blade 31 from FIG. 1 comprises a blade body 33, and comprises a fastening shaft 35, via which the saw blade 31 can be connected to a tool receiver, preferably a clamping device of a power tool, in particular to the first clamping means 1a and the second clamping means 1b. The blade body 33 and the fastening shaft 35 could be realized as a single piece. A longitudinal edge 39 of the blade body 33 constitutes a cutting edge 41 with cutting teeth 43 that extend between the fastening shaft 35 and the front tip of the blade body 33. The cutting edge 41 is substantially rectilinear; the cutting edge 41 might also have a slight convex/concave curve, at least partially. The saw blade 31 is provided with rectilinear and circular impressions 37, which are realized on the fastening shaft 35. Alternatively or additionally, the impressions 37 may be realized in the entire saw blade 31, in particular at a boundary region between the fastening shaft 35 and the blade body 33 of the saw blade 31, and/or have other geometric shapes of the impressions 37, differing from those of FIG. 1.

The impressions 37 on the saw blade 31 are realized, in particular, as hollows 55, on a side face 45 of the fastening shaft 35 of the saw blade 31, which, on the opposite side face 45 of the saw blade 31, are provided with prominences 53 corresponding to the hollows 55. The impressions 37 on the saw blade 31 have, at least partially, inverse contours of the structures 7 of the clamping means 1. The impressions 37 on the fastening shaft 35 are similar in form to the structures 7 of the clamping means 1, and thus have linear impressions 37, preferably arranged in the shape of a cross, which have a circular impression 37 at the point of intersection of a notional line of the linear impressions 37. The impressions 37 in the shape of a cross do not intersect, and represent merely one of many possible arrangements of the impressions 37. Alternatively or additionally, the impressions 37 may assume a form different from the structures 7 of the clamping means 1, wherein the impressions 37 should be matched, at least substantially, to the structures 7. The structures 7 of the first clamping means 1a and of the second clamping means 1b preferably effect engagement with the impressions 37 of the fastening shaft 35.

The fastening shaft 35 has a gripping tongue 36 and a through opening 17. The through opening 17 is realized, in particular, for fastening to the clamping means 1a, 1b in a form-closed manner. The through opening in this case increases the clamping force and safety of the tool receiver, in that a stud, or pin, not represented in greater detail, engages in the through opening and connects the fastening shaft to the tool receiver in a form-closed manner. Alternatively, the fastening shaft may be realized without the through opening. The gripping tongue is designed to make it easier to introduce the fastening shaft into a multiplicity of differing tool receivers in an effective and efficient manner. The gripping tongue has edges that act in combination with at least one element in the tool receiver and thus define the position of the saw blade in the tool receiver.

The gripping tongue 36 is provided with a first edge 47, a second edge 49 and a third edge 51. The gripping tongue 36 in this case is elongate in form, and can produce a form closure with the tool receiver, transversely in relation to the stroke direction a of the saw blade 31. The first edge 47 is preferably parallel to the stroke direction a of the saw blade 31, and preferably parallel to the cutting edge 41 of the blade body 33 provided with the cutting teeth 43. Alternatively or additionally, the first edge 47 may be arranged at an angle in relation to the stroke direction and/or in relation to the cutting edge 41 of the saw blade 31. The second edge 49 of the gripping tongue 36 is arranged at right angles to the first edge 47 of the gripping tongue 36, and is made substantially rectilinearly, but may also be provided at an angle other than a right angle. The second edge 49 is not limited to a rectilinear edge, but may assume any other form. The third edge 51 of the gripping tongue 36 is substantially parallel to the first edge 47, and is spaced apart from the first edge 47.

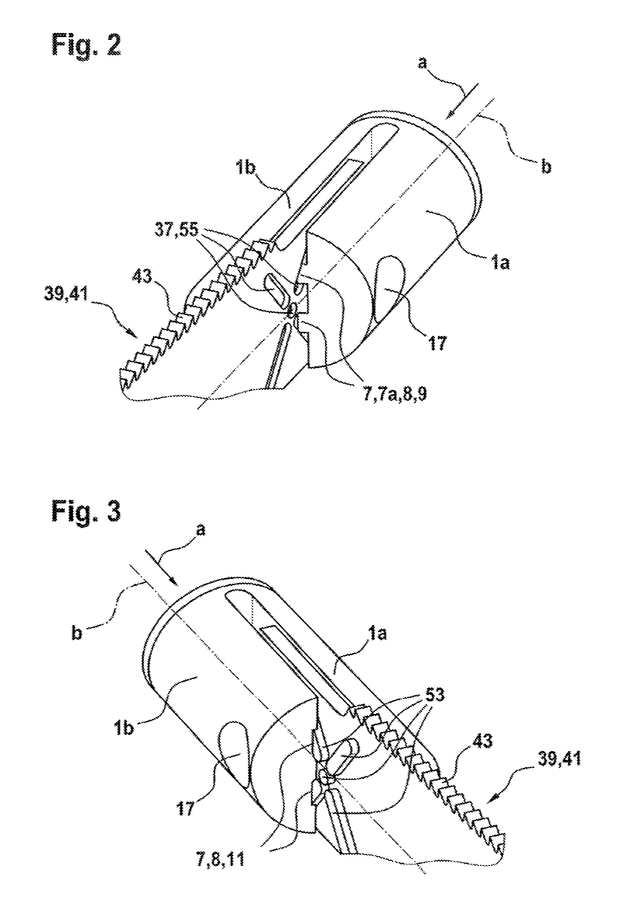

The tool receiver from FIG. 2 shows the saw blade 31, the first clamping means 1a and the second clamping means 1b. If the two clamping means 1 are brought together at the bearing contact faces 13, a gap is produced between the contact faces 15 of the clamping means 1. The fastening shaft 35 of the saw blade 31 in this case is inserted in a gap between clamping faces 15 of the two clamping means 1. The first clamping means 1a has been cut away axially as far as the through opening 17, and shows the engagement of two linear structures 7 of the first clamping means 1a in two linear impressions 37 of the saw blade 31. Here, the cut-away of the first clamping means 1a as far as the through opening 17 represents merely one type of visualization, and is not intended to be limiting. The through openings 17 of the two clamping means 1 are realized so as to be approximately concentric, the through openings 17 of the two clamping means 1a, 1b and the through opening 17 of the fastening shaft 35 overlapping each other over their full area, preferably overlapping at least partially. In particular, the through openings are arranged in relation to each other in such a manner that a rectilinear, in particular a curved, stud or pin can reach through the through openings 17 and thus prevent a movement, at least radially in relation to the stud. Alternatively, the first clamping means 1a and the second clamping means 1b may be realized so as to be separate.

FIG. 3 shows, as already evident from FIG. 2, the saw blade 31, the first clamping means 1a and the second clamping means 1b, from another perspective. In this case, the clamping means 1a and the clamping means 1b are realized as a single piece. The second clamping means 1b has been cut away axially, and shows the engagement of the linear structures 7 of the sawing power tool 1b with the impressions 37 in the fastening shaft 35 of the saw blade 31. The impressions 37, or the prominences, on the saw blade are also visible.

What is claimed is:

1. A sawing power tool, comprising:
a saw blade having at least one at least portionally inverse form-closure element; and
at least one clamping mechanism configured to fasten the saw blade to be driven with a stroke motion, the at least one clamping mechanism having at least one geometric structure that forms a form-closure element configured to form a connection to the at least one at least portionally inverse form-closure element of the saw blade.

2. The sawing power tool according to claim 1, wherein the at least one clamping mechanism has at least one recess.

3. The sawing power tool according to claim 1, wherein the at least one clamping mechanism has at least one protuberance.

4. The sawing power tool according claim 1, wherein the structure has a substantially linear or strip-type shape.

5. The sawing power tool according to claim 1, wherein the structure has a substantially rectilinear shape.

6. The sawing power tool according to claim 1, wherein the structure has an at least partially curved shape.

7. The sawing power tool according to claim 4, wherein the linear or strip-type structure is closed circumferentially.

8. The sawing power tool according to claim 4, wherein the linear or strip-type structure extends at least portionally in the longitudinal direction in relation to the stroke direction of the power tool.

9. The sawing power tool according to claim 4, wherein at least one structure extends at an angle in relation to the stroke direction of the power tool.

10. The sawing power tool according to claim 1, wherein the structure is configured in the shape of a cross.

11. The sawing power tool according to claim 1, wherein at least one structure on at least one of the clamping mechanisms extends as far as a side edge of the clamping mechanism.

12. The sawing power tool according to claim 1, wherein the sawing power tool is configured as a compass saw.

13. A saw blade for a hand-held power tool, comprising:
a blade body including a cutting edge with cutting teeth; and
a fastening shaft, wherein one or more of the blade body and the fastening shaft has at least one impression configured to form a connection to a form-closure element of the hand-held power tool.

14. A power tool system, comprising:
a tool receiver having at least one clamping mechanism; and
a compass blade or saw blade having (i) a blade body including a cutting edge with cutting teeth and (ii) a fastening shaft that is integral with the blade body and that is configured to fasten to the power tool,
wherein one or more of the blade body and the fastening shaft has at least one impression, and
wherein the at least one clamping mechanism has at least one structure that is inverse in relation to the impression of the saw blade.

15. The sawing power tool according to claim 1, wherein:
the sawing power tool is configured as a sawing hand-held power tool, and
the at least one clamping mechanism is configured to fasten a compass saw blade, the compass saw blade having a blade body including a cutting edge with cutting teeth and having a fastening shaft.

16. The sawing power tool according to claim 8, wherein the linear or strip-type structure extends parallelwise in relation to the stroke direction of the power tool.

17. The sawing power tool according to claim 9, wherein the at least one structure extends diagonally in relation to the stroke direction of the power tool.

18. The power tool system according to claim 14, wherein:
the power tool system is configured as a hand-held power tool system, and
the at least one structure is a form-closure element that is at least partially inverse in relation to the impression of the saw blade.
